(19) United States
(12) Patent Application Publication
(10) Pub. No.: US 2018/0340493 A1
(43) Pub. Date: Nov. 29, 2018

(54) AIRCRAFT ENGINE HAVING AT LEAST ONE REVERSE THRUST SYSTEM ACTUATOR ARRANGED IN A GAS EXHAUST CONE

(71) Applicant: Airbus Operations (S.A.S.), Toulouse (FR)

(72) Inventors: Olivier CAZALS, BLAGNAC (FR); Guillaume GALLANT, LAREOLE (FR)

(21) Appl. No.: 15/985,646

(22) Filed: May 21, 2018

(30) Foreign Application Priority Data
May 23, 2017 (FR) 1754582

(51) Int. Cl. F02K 1/62; B64D 27/14; B64D 29/00

(52) U.S. Cl. CPC F02K 1/625; B64D 29/00; B64D 27/14

(57) ABSTRACT

To reduce the size of an aircraft engine, an assembly is disclosed including a nacelle section, a gas exhaust cone positioned radially towards the inside in relation to the nacelle section and forming therewith an annular gas exhaust channel, and a reverse thrust system including moveable gas diversion elements for the gas flowing in the annular channel, at least one actuator and a transmission device linking the at least one actuator to the moveable gas diversion elements. Furthermore, the actuator is located inside the gas exhaust cone.

### CROSS-REFERENCE TO RELATED APPLICATION

This patent application claims priority to French patent application FR 17 54582, filed on May 23, 2017, the entire disclosure of which is incorporated by reference herein.

### TECHNICAL FIELD

The disclosure herein relates to the domain of aircraft engines, and in particular to the reverse thrust systems fitted to such engines.

The disclosure herein is preferably but not exclusively applied to boundary-layer ingestion propulsion engines that are designed to be installed on the rear portion of the fuselage of the aircraft. In a known manner, boundary-layer ingestion propulsion involves the ingestion by the engines of an air flow with low kinetic energy flowing about the rear portion of the fuselage. This technique is intended to reduce the energy required for propulsion and the drag of the aircraft, thereby resulting in reduced fuel consumption.

The disclosure herein applies preferably to commercial airplanes. The disclosure herein can also be applied to military airplanes fitted with turbo-jet engines or electric motors.

### BACKGROUND

In existing aircraft, the engines are provided with a reverse thrust system, in which the actuators are usually seated inside the nacelle. Numerous designs are already known, such as the one described in document FR 2964704, for example.

The installation of the actuators in the nacelle may increase the thickness thereof and further increase the size of the engine, which is already highly constrained by the search for high by-pass ratios. Indeed, ultra-high by-pass ratio engines have fans of increasingly large diameter in order to improve performance in terms of fuel consumption. Overdimensioning the nacelle thickness to receive the actuators of the reverse thrust system also increases the external diameter of the engine and the wetted area.

There is therefore a need to optimize the engine to reduce the size thereof.

### SUMMARY

To at least partially address this need, the disclosure herein relates to an aircraft engine assembly comprising:
a nacelle section,
a gas exhaust cone positioned radially towards the inside in relation to the nacelle section and forming therewith an annular gas exhaust channel,
a reverse thrust system including moveable gas diversion elements, at least one actuator and a transmission device linking the at least one actuator to the moveable gas diversion elements.

According to the disclosure herein, the moveable gas diversion elements are arranged such as to divert the gases flowing through the annular gas exhaust channel, and the at least one actuator is positioned inside the gas exhaust cone. Consequently, by implementing a more central installation in the engine, i.e. in the gas exhaust cone, the actuator or actuators of the reverse thrust system increase the size of the nacelle less than the actuators in the prior art.

The disclosure herein can also have at least one of the following additional features, taken individually or in combination.

The reverse thrust system has first and second moveable gas diversion elements, the first elements being deployable between an inactive withdrawn position and a reverse thrust position in which the elements project into the annular gas exhaust channel, and the second elements being deployable between an inactive withdrawn position and a reverse thrust position in which the elements project radially towards the outside of the nacelle section.

The nacelle section has an inner skin traversed by first openings and an outer skin traversed by second openings, the first moveable gas diversion element closing the first openings when the elements are in the inactive withdrawn position, and the second moveable gas diversion elements closing the second openings when the elements are in the inactive withdrawn position.

The first and second moveable gas diversion elements are jointed on the nacelle section, preferably in radially opposing pairs.

The gas exhaust cone is static, and the outer skin thereof is provided with through-holes to enable at least some elements of the transmission device of the reverse thrust system to pass through.

Alternatively, the gas exhaust cone comprises two longitudinal portions, one being static and the other moveable in translation in a longitudinal direction of the assembly.

The disclosure herein also relates to an aircraft engine comprising:
a gas generator,
a nacelle,
a receiver driven by the gas generator and surrounded by the nacelle,

The engine including an assembly such as the one described above.

Preferably, the gas generator is arranged upstream of the receiver, and the receiver has a fan, the assembly being arranged downstream of the fan.

Preferably, the engine is a dual-flow engine, and is preferably designed such that the two flows pass through the annular gas exhaust channel. Alternatively, the fan could be supplied by an offset gas generator.

Finally, the disclosure herein also relates to an aircraft having at least the engine, preferably arranged in the rear portion of the aircraft, the engine preferably being a boundary-layer ingestion propulsion engine. The fan may be fed by any means or mechanism other than a gas generator, such as an electric motor for example.

Alternatively, the engine may be installed conventionally beneath the wing of the aircraft, without thereby moving outside the scope of the disclosure herein.

Other advantages and characteristics of the disclosure herein are set out in the non-limiting detailed description given below.

### BRIEF DESCRIPTION OF THE DRAWINGS

This description is made with reference to the attached, example drawings, in which:

FIG. 1 is a perspective view of an aircraft according to the disclosure herein;

FIG. 2 is a magnified perspective view of a rear portion of the aircraft shown in the previous figure;

FIG. 3 is a longitudinal cross-section view of a rear portion of the aircraft shown in the previous figure;

FIG. 4 is a cross-section view of an assembly according to a first preferred embodiment of the disclosure herein, belonging to an engine in the rear portion shown in the previous figure;

FIG. 5 is a perspective view of the assembly shown in the previous figure,

FIG. 6 is a perspective view of the assembly shown in the previous figure, from another viewing angle;

FIG. 7 is a cross-section view similar to the view in FIG. 4, with the assembly in the reverse thrust position;

FIG. 8 is a rear view of the assembly shown in FIG. 7; and

FIG. 9 is a perspective view similar to the view in FIG. 5, with the assembly in the form of a second preferred embodiment of the disclosure herein.

### DETAILED DESCRIPTION

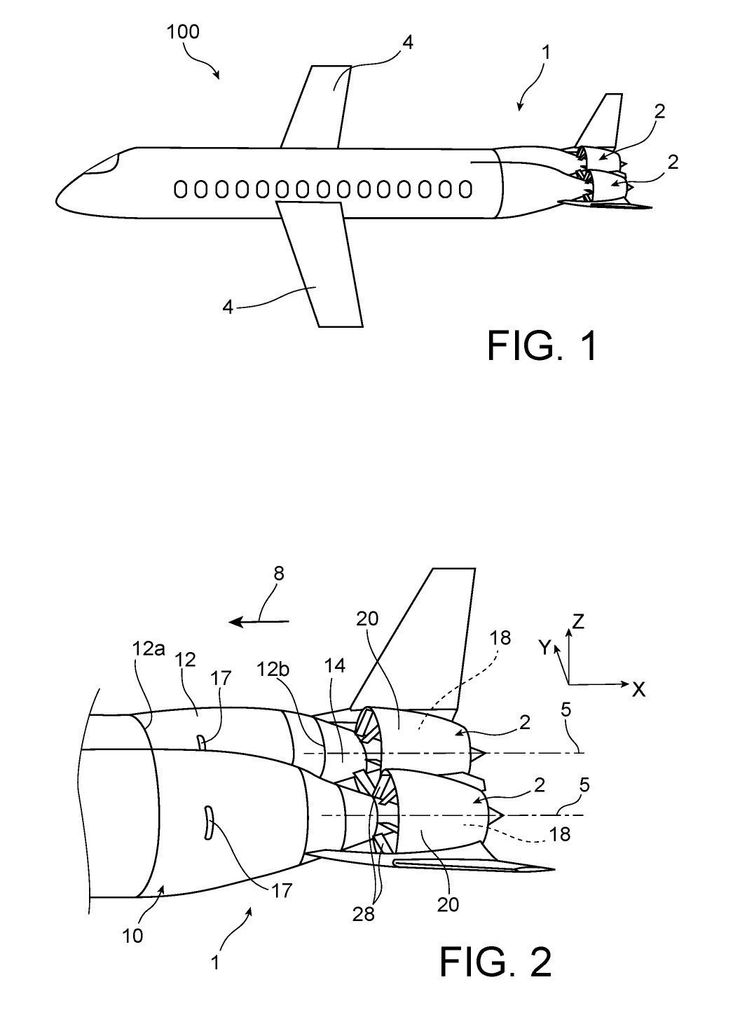

With reference firstly to FIG. 1, the figure shows a commercial aircraft 100 having a rear portion 1 provided with engines 2. The wings 4 of the aircraft are not fitted with engines, although the wings could be fitted with engines without thereby moving outside the scope of the disclosure herein.

In the description below, the terms “front” and “rear” shall be understood in relation to a direction 8 of forward movement of the aircraft as a result of thrust generated by the engines 2, while the terms “upstream” and “downstream” shall be understood in relation to a main gas flow observed in a direction opposite the direction 8.

With reference to FIGS. 1 through 3, the rear portion 1 has a rear fuselage portion 10 forming the rear end of the fuselage of the aircraft. This portion 10 has a front portion 12, the front end 12a of which has an oval, circular or other fuselage shape. Moving towards the rear end 12b of same, the front portion 12 is gradually narrowed at the centre before splitting into two separate rear fuselage portions, indicated using reference sign 14. The two rear fuselage portions 14, which are preferably identical and revolution shaped, are set apart from one another in a transverse direction Y of the assembly. In this regard, and by convention, the direction X shall refer to the longitudinal direction of the rear portion 1, which is similar to the longitudinal direction of each engine of this assembly 1. This direction X is parallel to a longitudinal axis 5 of each engine 2. Furthermore, the direction Y corresponds to the direction oriented transversely in relation to the longitudinal direction of the rear portion 1 and also similar to the transverse direction of each engine, while the direction Z corresponds to the vertical direction or height. These three directions X, Y and Z are mutually orthogonal and form a right trihedron.

Each rear fuselage portion 14 is designed to incorporate all or part of one of the engines 2. Consequently, in the preferred embodiment that has two engines spaced apart in the direction Y, there are two rear fuselage portions 14. In a different case in which a third engine is added and spaced apart from the first two engines in both directions Y and Z, such as to form a triangle arrangement, there are then three rear fuselage portions. If there are four engines, the engines can be arranged in a square or a rectangle, and are built into four rear fuselage portions 14 respectively.

In the preferred embodiment shown in FIGS. 1 through 3, there are therefore two rear fuselage portions 14 that are spaced apart from one another in the direction Y and run parallel to the direction X from the rear end 12b of the fuselage portion 12. Each rear fuselage portion 14 is centred on the longitudinal axis 5 of the related engine 2. Each engine is in this case a turbo-jet engine with ingestion of the boundary layer flowing over the corresponding rear fuselage portion 14.

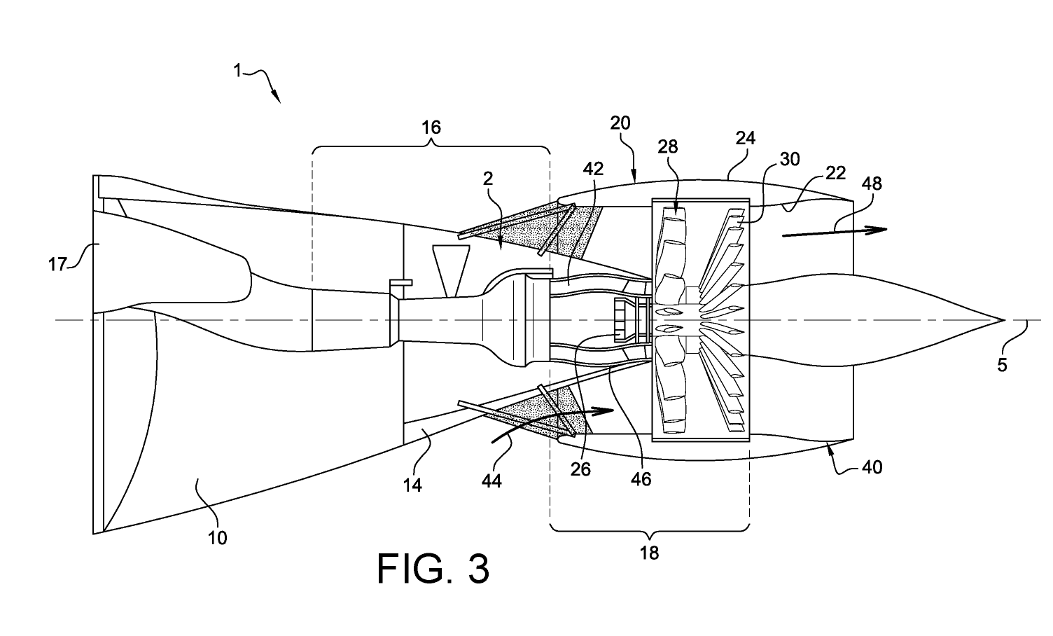

With reference more specifically to FIG. 3, this figure shows one of the two engines 2, the design of which is described below and also applies to the other engine. The engine 2 is first fitted with a gas generator 16 located in the rear fuselage portion 14. This generator, which is the embedded upstream portion of the engine, is of conventional design, i.e. comprising a combustion chamber arranged between a compressor unit and a turbine unit. This gas generator 16 is supplied with cold air by the scoops 17 arranged on the rear fuselage portion 14 upstream of the generator 16.

The engine 2 also has a receiver 18 driven by the gas generator 16. The receiver 18 is surrounded by an engine nacelle 20 that is formed by an inner nacelle skin 22 and an outer nacelle skin 24. The reduction gear 18 preferably includes, from upstream to downstream, a reduction gear 26, a fan 28 and a series of outlet guide vanes (OGV) 30 The assembly 40 according to the disclosure herein, as described in greater detail below, is arranged downstream of the fan 28 and of the vanes 30.

Again with reference to FIG. 3, it can be seen that the engine 2 has a dual-flow design. This includes firstly a primary flow or hot flow 42 emitted by the generator 16. It also includes a secondary flow or cold flow 44 passing about the primary flow and flowing between the inner nacelle skin 22 and the rear fuselage portion 14.

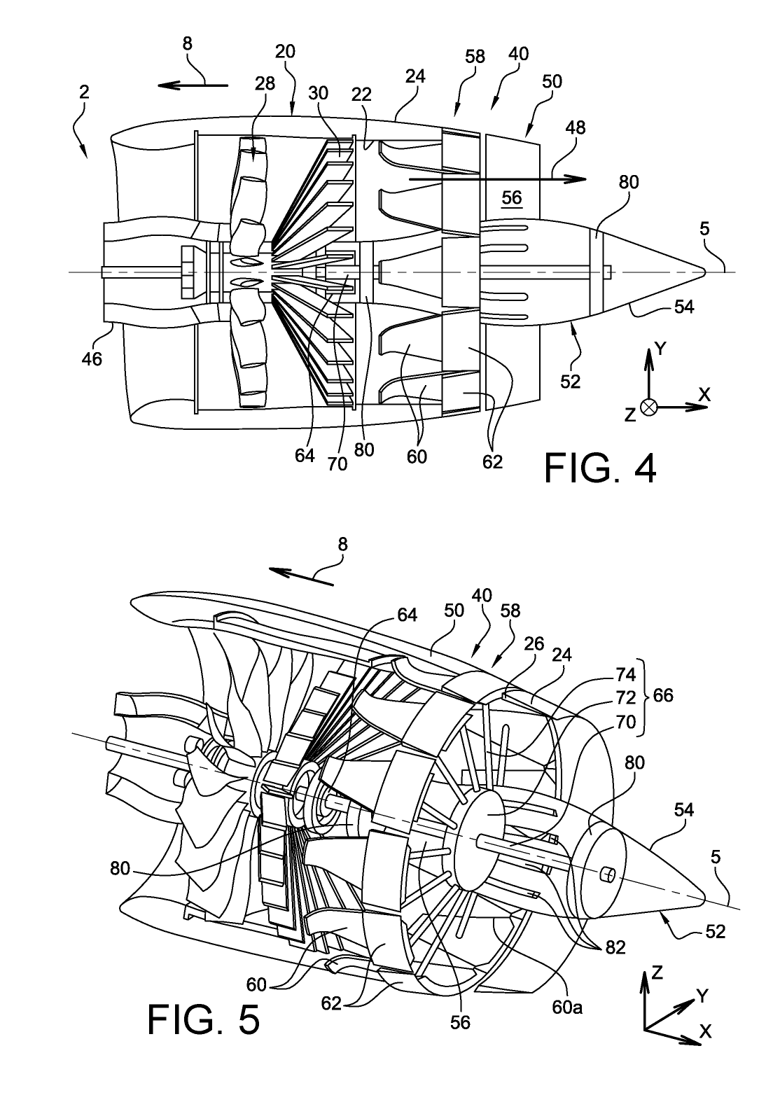

The primary flow 42 flows through an annular duct 46 surrounding the reduction gear 26, before passing through the fan 28 and the outlet guide vanes 30. At this stage, the primary flow 42 mixes with the secondary flow 44 to form a single flow 48 passing through the assembly 40, a first preferred embodiment of which is described below with reference to FIGS. 4 through 8.

Firstly, FIGS. 4, 5 and 6 show the assembly 40 according to the disclosure herein in a normal cruising configuration, during which the mixed gas flow 48 passes through the assembly 40. This latter has a rear nacelle section 50 that is also defined by the skins 22 and 24. Radially towards the inside and centred on the axis 5, the assembly 40 has a gas exhaust cone 52. This cone 52 begins directly downstream of the bases of the outlet guide vanes 30 and extends backwards as far as the tip of the cone. Thus, the cross section of the cone increases then decreases from front to back, as shown for example in FIG. 4.

This cone has an outer skin 54 that defines an annular gas exhaust channel 56 with the inner skin 22 of the nacelle. The assembly 40 also has a reverse thrust system 58 that is specific to the disclosure herein. Indeed, this system has first and second moveable gas diversion elements 60, 62 for the gas flowing in the annular channel 56. These door-shaped elements 60, 62 are driven by at least one actuator 64 via a transmission device 66. One of the specificities of the disclosure herein is that the actuator or actuators 64 are seated in the gas exhaust cone 52. Thus, the actuators 64 are arranged inside the space defined by the skin 54 of the cone 52 and are therefore arranged radially towards the inside in relation to the moveable deviation elements 60, 62. This design differs from the embodiments in the prior art in which the actuators are usually arranged in the thickness of the nacelle in a place where the actuators significantly and adversely affect the size of the nacelle. The installation of the actuators 64 at the centre of the engine may require the use of suitable thermal protection on the cone to insulate these actuators from the single flow 48, which is nonetheless relatively cold as a result of being a mixture of the primary flow 42 and the secondary flow 44 (or just a secondary flow).

The actuator or actuators 64 are of conventional design, for example jacks or linear motors. The transmission device 66 is mechanical and for example comprises the following elements, as shown in FIG. 5: firstly, a transmission shaft 70 cooperating directly with the actuator 64. This shaft 70 is centred on the axis 5 and is rigidly connected to a disk 72, and connecting rods 74 are jointed about the periphery of the disk to drive the first deviation elements 60. Furthermore, the outer end of each connecting drive rod 74 is jointed on one of the first deviation elements 60.

In this regard, it should be noted that the rear end of each first deviation element 60 is jointed to the inner skin 22 of the nacelle. There are first openings 60a in this skin 22 that are closed by the first deviation elements 60 when the latter are in the inactive withdrawn position, as shown in FIGS. 4 and 5. Thus, in this position, the first deviation elements 60 help to delimit the annular channel 56 by forming a portion of the inner nacelle skin 22.

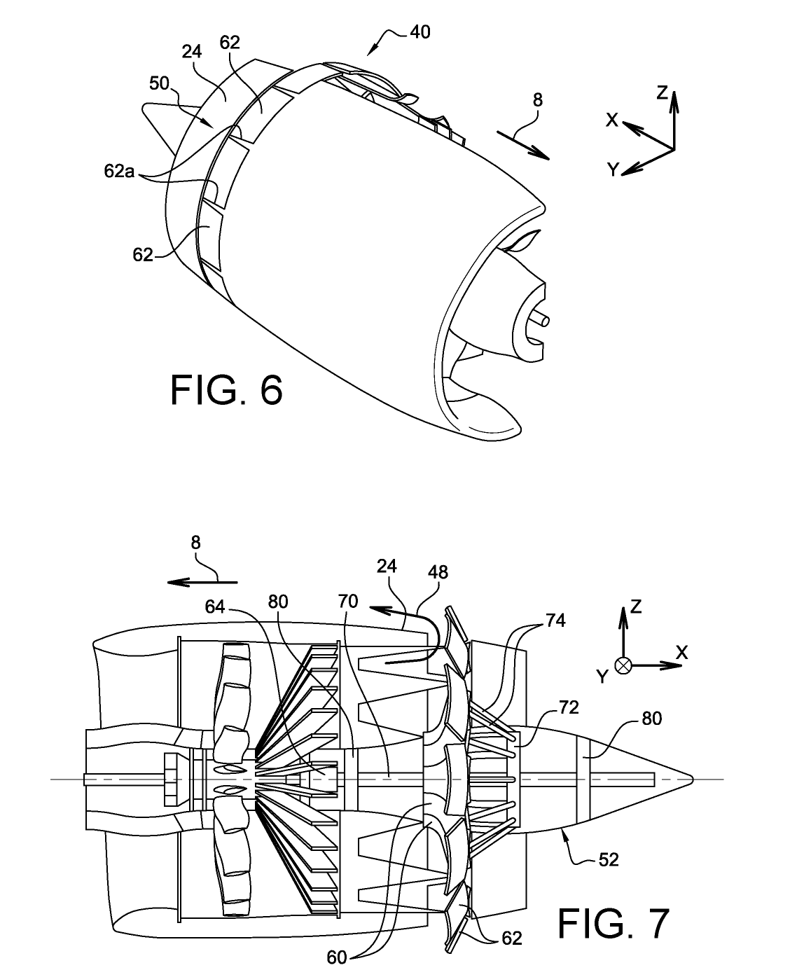

Similarly, the outer nacelle skin 24 has second openings 62a that are closed by the second deviation elements 62 when the latter are in the inactive withdrawn position, as shown in FIGS. 4 and 6. Thus, in this position, the second deviation elements 62 help to delimit the annular channel 56 by forming a portion of the outer nacelle skin 24. The rear end of each deviation element 62 is in turn jointed to the outer nacelle skin 24. Each deviation element is also linked to the inwardly radially opposing first deviation element 60. A conventional linking device (not shown) is provided between the two deviation elements 60, 62, this device enabling the second deviation element 62 to be moved in response to the movement of the first deviation element 60 generated by the actuator 64 and the transmission device 66.

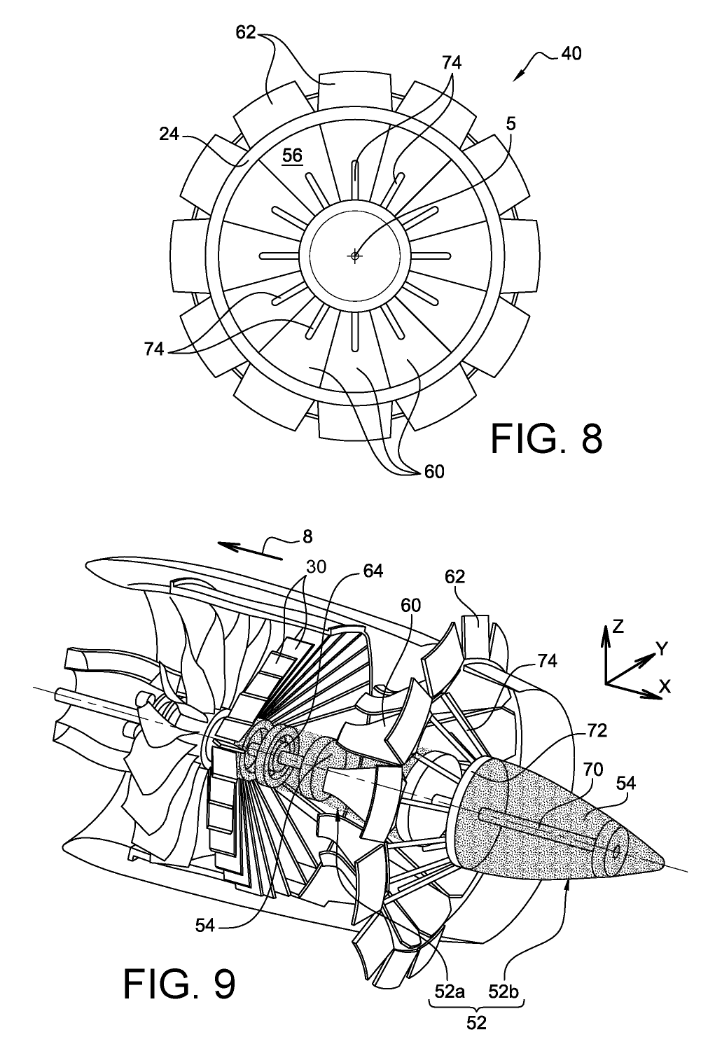

As shown in FIG. 7, when the reverse thrust mode is activated, the actuator 64 causes the transmission shaft 70 to move downstream inside the gas exhaust cone 52. To do so, the shaft is guided in translation by the static disks 80 arranged inside the cone 52. By moving downstream, the transmission shaft 70 drives the disk 72 and the connecting rods 74, the outer ends of which tend to move radially inwards. The first deviation elements 60 then tend to move towards a reverse thrust position shown in FIGS. 7 and 8. In this position, the first elements 60 close all or part of the gas exhaust channel 56 by pressing against the outer skin 54 of the cone 52. Simultaneously, the second deviation elements 62 tend to deploy in a reverse thrust position in which the elements project radially outwards from the nacelle skin 24. The link between the different elements 60, 62 creates a wallet-style opening of the door-shaped elements, the first elements 60 being provided to form a barrier inside the annular gas exhaust channel 56 and the second elements 62 being provided to redirect the mixed gas flow 48 in the direction 8, outside the engine.

It should be noted that the pivoting and backwards movement of the connecting rods 74 are possible due to the presence of the slot-shaped through-holes 82 formed in the skin 54 of the cone 52.

FIG. 9 shows a second preferred embodiment of the disclosure herein in which the design does not require the presence of slots 82. Instead of being a static single part, the cone 52 is segmented into two longitudinal portions 52a and 52b. The frontmost portion 52a, which begins directly downstream of the vanes 30, is static in relation to the rest of the engine. Conversely, the rearmost portion 52b is moveable in translation in relation to the first portion 52a in the direction X. FIG. 9 shows an intermediate position between the inactive withdrawn position of the moveable gas diversion element 60, 62 and a reverse thrust position. In the inactive position, the two longitudinal portions 52a, 52b are arranged in line with one another such as to form together a cone having the same or a similar shape to the cone according to the first preferred embodiment. Conversely, when the reverse thrust position is activated, the rearmost portion 52b moves backwards with the transmission shaft 70, which slides in relation to the frontmost portion 52a in the direction X. In this second preferred embodiment of the disclosure herein, the disk 72 is the front closing disk of the portion 52b. By moving backwards with this portion 52b, the disk 72 drives the connecting rods 74 backwards and pivotingly, such that the outer ends of same move radially inwards. The retreat of the portion 52b also causes the moveable gas diversion elements 60, 62 to pivot.

Naturally, a person skilled in the art may make different modifications to the disclosure herein described above purely by way of non-limiting example. In particular, the embodiments described above are not mutually exclusive, but conversely can be combined with one another.

While at least one exemplary embodiment of the disclosure herein(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly for an aircraft engine comprising:
a nacelle section;
a gas exhaust cone positioned radially towards an inside in relation to the nacelle section and forming therewith an annular gas exhaust channel; and
a reverse thrust system including moveable gas diversion elements, at least one actuator and a transmission device linking the at least one actuator to the moveable gas diversion elements,
wherein the moveable gas diversion elements are arranged to divert gases flowing through the annular gas exhaust channel, and wherein the at least one actuator is positioned inside the gas exhaust cone.

2. The assembly according to claim 1, wherein the reverse thrust system has first and second moveable gas diversion elements, the first elements being deployable between an inactive withdrawn position and a reverse thrust position in which the elements project into the annular gas exhaust channel, and the second elements being deployable between an inactive withdrawn position and a reverse thrust position in which the elements project radially towards an outside of the nacelle section.

3. The assembly according to claim 2, wherein the nacelle section has an inner skin traversed by first openings and an outer skin traversed by second openings, the first moveable gas diversion elements closing the first openings when the elements are in the inactive withdrawn position, and the second moveable gas diversion elements closing the second openings when the elements are in the inactive withdrawn position.

4. The assembly according to claim 2, wherein the first and second moveable gas diversion elements are jointed on the nacelle section in radially opposing pairs.

5. The assembly according to claim 1, wherein the gas exhaust cone is static, and wherein the outer skin thereof is provided with through-holes to enable at least some elements of the transmission device of the reverse thrust system to pass through.

6. The assembly according to claim 1, wherein the gas exhaust cone comprises two longitudinal portions, one being static and another moveable in translation in a longitudinal direction of the assembly.

7. An aircraft engine comprising:
a gas generator;
a nacelle; and
a receiver driven by the gas generator and surrounded by the nacelle,
wherein the engine comprises an assembly comprising:
a nacelle section;
a gas exhaust cone positioned radially towards an inside in relation to the nacelle section and forming therewith an annular gas exhaust channel; and
a reverse thrust system including moveable gas diversion elements, at least one actuator and a transmission device linking the at least one actuator to the moveable gas diversion elements,
wherein the moveable gas diversion elements are arranged to divert gases flowing through the annular gas exhaust channel, and wherein the at least one actuator is positioned inside the gas exhaust cone.

8. The aircraft engine according to claim 7, wherein the gas generator is arranged upstream of the receiver, and wherein the receiver has a fan, the assembly being arranged downstream of the fan.

9. The aircraft engine according to claim 7, wherein the aircraft engine is a dual-flow engine and is configured such that the two flows pass through the annular gas exhaust channel.

10. An aircraft having at least one engine that is arranged in a rear portion of the aircraft and that is a boundary-layer ingestion propulsion engine, the engine comprising:
a gas generator;
a nacelle; and
a receiver driven by the gas generator and surrounded by the nacelle,
wherein the engine comprises an assembly comprising:
a nacelle section;
a gas exhaust cone positioned radially towards an inside in relation to the nacelle section and forming therewith an annular gas exhaust channel; and
a reverse thrust system including moveable gas diversion elements, at least one actuator and a transmission device linking the at least one actuator to the moveable gas diversion elements,
wherein the moveable gas diversion elements are arranged to divert gases flowing through the annular gas exhaust channel, and wherein the at least one actuator is positioned inside the gas exhaust cone.
